(19) United States
(12) Patent Application Publication
(10) Pub. No.: US 2011/0277362 A1
(43) Pub. Date: Nov. 17, 2011

(54) Direct point LED signs

(76) Inventor: William Ahmadi, San Gabriel, CA (US)

(21) Appl. No.: 12/800,380

(22) Filed: May 17, 2010

(51) Int. Cl. G09F 13/06; G09F 13/12; G09F 13/04

(52) U.S. Cl. 40/552; 40/582; 40/564

(57) ABSTRACT

A direct point LED sign employs the use of flat head LED's embedded within a mirrored reflective panel where an upper layer of varying distance from the mirrored surface comprises a crushed ice diffuser with an irregular front surface which reflects and intensifies light passing therein creating an enlarged surface area of the LED's. This in turn greatly increases the readability of the character members in road and highway signs, commercial signs, or individual letters, numbers, and symbols.

This application is entitled to the benefit of patent application No. 61/210,168 filed on Mar. 16, 2009, and provisional application No. 61/214,612 filed on Apr. 27, 2009

### BACKGROUND OF THE INVENTION

1. Field of the Invention

This invention relates to an electrical or solar powered sign used for roads, highways and freeways, in addition to commercial signs, address numbers or letters, with a crystal background employing light emitting diode's (LED'S).

2. Prior Art

Illuminated signs, house numbers, characters and logos have been around for some time now employing different means of illumination, reflection and or diffusion. For example illumination of character indicia by bulbs, florescent bulbs, light emitting diodes and photochemical processes are well known in the art.

For example U.S. Pat. No. 7,513,072 teaches the production of an edge—illuminated sign having a large relief effect with figures, text, and objects recessed within transparent material whereby from the outside its appearance is a raised relief image. A laser beam is employed to vaporize light guiding material to create the relief.

U.S. Pat. No. 7,220,019 teaches a multi colored LED illuminated signs, or house numbers where said sign or house number contains a reflective inner surface and a scattering reflective surface on the base panel, where there are a plurality multi-colored LED's mounted to a circuit board adjacent to an end wall. A front cover is comprised of a top transparent panel and a diffuser unit.

Another example of an illuminated home number signs is U.S. Pat. No. 6,901,688 discloses an illuminated home number sign having an illumination source of a florescent tube embedded between a first and second translucent pane. This illuminated sign also teaches of a dual switching system to power on and off the device. One part of the system is actuated by ambient light sensors, whereby the other part of the system is manually controlled.

However the above description lacks either a reflective unit or a diffusing unit both of which are used to greatly enhance the outgoing illumination from the sign.

Other examples of illuminated signage are found in U.S. Pat. Nos. 5,105,568, 5,539,623, 5,388,357, 4,952,023, 6,762,562, 6,367,180 and 4,937,499.

### SUMMARY OF THE INVENTION

The present inventions embodiments relates to road and highway signs, commercial letters and numbers and other such devices including home address numbers shapes or logos.

An objective of the current invention is to provide a sign with reduced electricity usage, reduced maintenance costs and an improved visibility of its character members from more than twice the distance of today's signs.

This objective is met by producing a sign apparatus with a box shape wherein a face panel lies on one or both sides of the exterior and consist of lexan. A stenciled layer of masking film is applied to the inside layer of the lexan face panel. Attached to the inner side of said lexan panel is a gasket which provides a permanent seal between the inside of the sign and its outside. Directly behind the lexan face panel, which is transparent, is the crushed ice sheet of which the stenciled portion of the masking film layer bear alpha numeric characters that are seen by the viewer. The crushed ice surface effectively reflects sunlight around and within the characters of the face panel back toward the viewer during daylight hours. During night hours At least one light emitting diode (LED) is preferably mounted within a plastic reflective mirror panel.

The LED's are flat head so that during the night hours the illumination of the individual LED is magnified several times, producing a large bulb effect. Thus the crushed ice sheet enhances the readability of the sign during daytime hours, while scattering and enhancing the illumination produced by the LED lights during nighttime hours. Said LED's are wired together by parallel wiring attached together by electrical connectors also wired to circuit board inside.

Along the upper surface of the sign is a planar shaped external member consisting of a plurality of pre-drilled holes which serve as receptacles for extension spacer inserts, which are narrow diameter cylinders that serve as receptacles for the long bolts and are welded to the upper surface panel.

Two long shaft bolts are inserted through two large diameter pre-drilled holes running the length of the sign. The two shaft bolts are bolted in place securing the entirety of said signs frame while insuring its rigidness.

Another object of the present invention is to reflect ambient light from automobile lights, street lights, etc., to be reflected back towards the viewer off of the reflective crushed ice sheet which surrounds the masking film and indicia. The light reflected back is amplified greatly thus increasing the visibility of the sign and its characters. The angular position of the viewer relative to the sign results in a sparkling effect of reflected light for one viewer and a prismatic effect of illumination for the another viewer in a different physical position relative to the sign.

Another embodiment of the present invention incorporates the use of solar energy to power the LED's. A dome enclosure houses a battery array which is attached to the upper external member. This solar battery array is comprised of a plurality of electrically connected solar cells and the array is mounted atop a hard plastic substrate. The substrate is attached to a metallic solar array frame assembly by means of a bonding adhesive, said solar array frame attached to said upper external member by means of welds. The solar cells charge the solar batteries within the array and are attached by series, parallel, or series-parallel wiring to operate the various circuits within the sign.

As the present invention is intended to be produced in a number of sizes, the number of solar panels used on a given sign will depend on the number of batteries used, in a given sized sign.

Yet another embodiment of the present invention includes the creation of individual 3D alpha numeric characters and symbols consisting of a plastic or metallic molding light guide formed into the chosen number, letter, symbol etc., wherein a slightly smaller in width character shape, of mirrored plastic fits into, lying along its entire diameter on an inner ledge formed of and inside of said enclosure near its base. Embedded along the center surface of the mirrored plastic lies a plurality of evenly spaced LED lights, available in a plurality of colors and displays.

A second upper ledge-like surface lies near the top of the enclosure wherein a crushed ice character sheet is secured bordered by the light guide frame. This crushed ice panel magnifies escaping light from the characters mirrored surface producing a globe like illumination from the flat head LED in conjunction with the distance between the mirror surfaced LED character shaped member, from the crushed ice character panel.

An object of the present invention is to create a void between a mirrored surface embedded with a plurality of LED's, and the crushed ice character surface above it, magnified LED's which appear several times larger than their actual size, as the light is refracted out towards the viewer's eyes.

Yet another object of the present invention is to retrofit existing freeway signage with letters numbers and symbols, pre fitted to replace existing letters, numbers, and symbols. The retrofit may or may not include LED illumination. The resulting replacement of characters for freeway signs results in a far more readable sign, from a further distance away under any weather condition during daylight hours. During nighttime hours, without use of LED's, the diffusion of ambient light produces far brighter letters, numbers and symbols. However this brighter nighttime illumination is soft yet far more powerful when LED's are used inside the diffuser.

Such form of illumination can effectively prevent the usage and need for under sign illumination fixtures which use standard florescent illumination tubes to illuminate the sign. This in turn will drastically reduce the amount of electricity used and the costs incurred by various cities, towns and provinces.

A fixed controller system may be employed to manage various functions of a message board such as on and off switching, blinking, and displaying fixed messages or characters. The controller switches off or on various characters within said display in a desired pattern that is fixed.

### DRAWINGS

### Brief Description of the Drawings

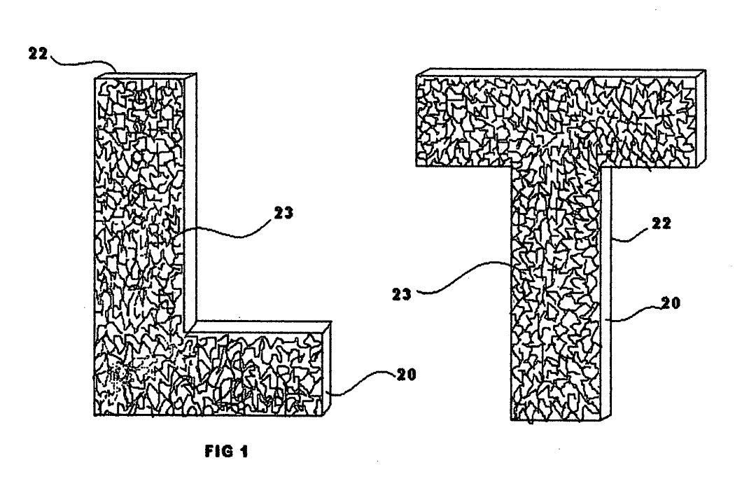

FIG. 1 is a frontal and partial side cross section of three character signs.

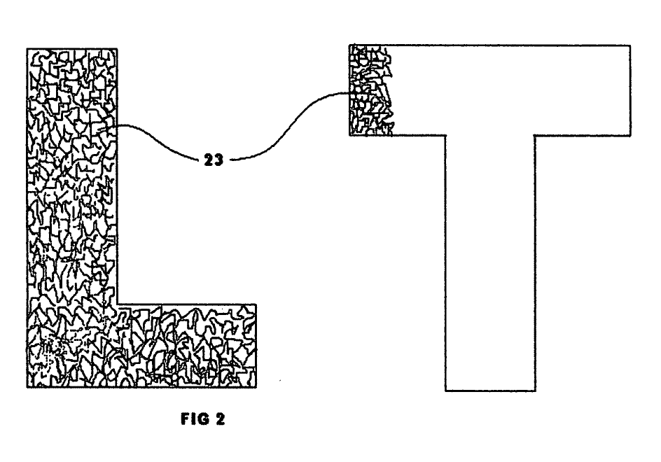

FIG. 2 is a front view of a box sign and its diffuser panel during daylight hours.

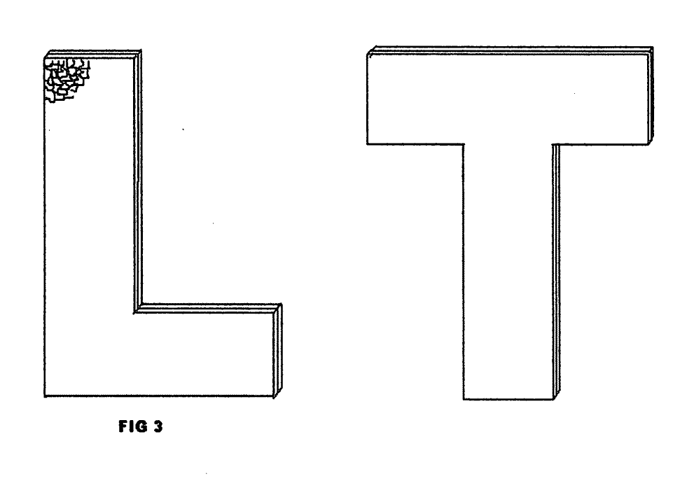

FIG. 3 is a side view of the box sign including framing and panel.

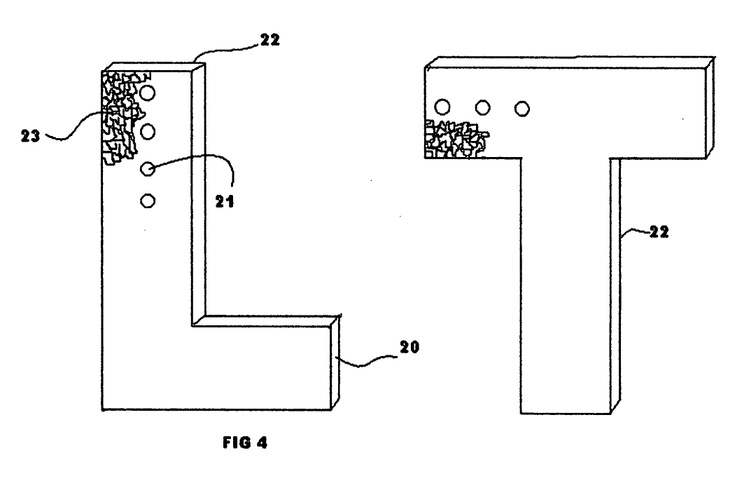

FIG. 4 is a front view of a photographed box sign

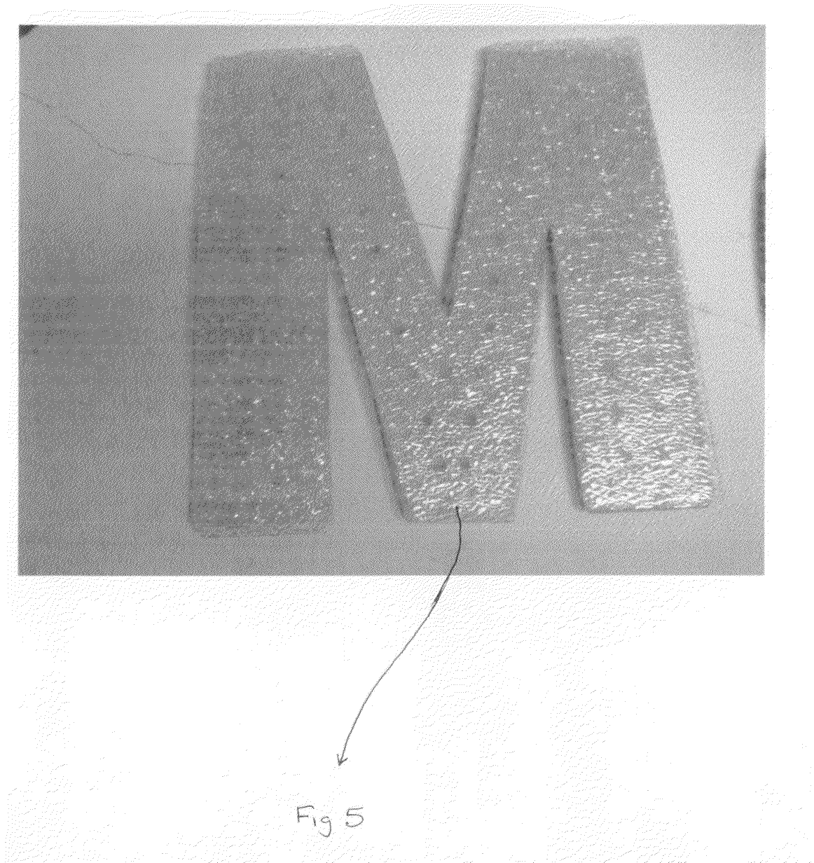

FIG. 5 is a front view of a character shape with LED lights embedded into its mirror surface

### DETAILED DESCRIPTION OF THE DRAWINGS

And now we take a closer look at the drawings. FIG. 1 illustrates a frontal view of three character signs with a slight right side cross section of the characters giving a three dimensional view of the depth of said characters. First is the alpha numeric character T. The internal base within the light guiding frame 20 consist of a mirrored reflective planar surfaced member shaped as the light guiding frame 20 of which at least one LED 21 is embedded via small hole openings where a plurality of flat top LED members 21 are inserted. Said LED 21 members are wired in series or parallel along the rear reflective mirror surface member. Placed right atop the flat LED members 21 fitted upon an upper ledge within the light guide frame 20 is an irregular front surfaced prismatic crushed ice diffuser 23 shaped as the light guiding frame 20. The diffuser 23 acts to scatter illumination towards the viewer that is reflected off of the rear mirror through the diffuser 23 produced from the LED members 21. The effect in essence more than doubles the circumference area of the LED member 21 while providing more than sufficient illumination during night hours to effectively illuminate said character for a viewer from a greater distance away from the light source.

The alphabetic characters E and L in FIG. 1 are an example of self illuminating character members without the upper prismatic crushed ice diffuser. The light guiding frame 20 supports the mirrored reflective surface 22 wherein a plurality of LED members 21 are embedded. Said LED members 21 are wired together along the backside of said mirrored reflective surface 22 and connected to a power source.

The character signs are in turn wired together to said power source. The switching control to power the unit can be a manual control or can be timed through a controller unit with a sensor that activates the unit after a certain time or after a fixed level of light has been achieved.

FIG. 2 illustrates a front view of a box sign during daylight hours. During the day the illuminating source, the LED's, are not visible to the naked eye. Instead, the prismatic crushed ice diffuser 23 is visible. Aligned along the inner surface of the exterior transparent face panel in front of the diffuser panel 23 is a mask of film carrying the indicia of said sign. During daylight hours only the diffuser 23 is seen through the indicia whereby daylight reflects off said diffuser 23 producing a sparkling effect without use of any illumination from within said sign. Thus a more visible sign is maintained throughout day and night.

FIG. 3 illustrates a side view of the box sign including framing and diffuser. In the front portion of the sign or character lies the prismatic crushed ice diffuser 23 which scatters illumination reflected by the mirrored reflective surface 22 from the light source, LED's 21. The backside light guide frame 20 encloses all of the above within a plurality of character shapes, sizes and or logos etc.

Thus said illumination source, where at least a single LED 21 is embedded appears from A frontal view, when illuminated, to be magnified. That is, the diffuser 23 causes the light source, the LED 21 to appear as a globe like bulb several times larger than the actual LED 21 source when illuminated.

FIG. 4 is a front view of a photograph of the box sign shown to illustrate the night time effect of the sign and its illumination thereof. As is seen in said photograph the border area of said sign is layered with the prismatic material of the signs diffuser 23. Said diffuser clearly is shown to magnify said illumination source, LED lights 21. The sparkling effect of said diffuser 23 is clearly seen by a viewer form a reasonable distance away.

FIG. 5 is a front view of a character shapes mirror reflective surface 22 which in turn is embedded with a plurality of LED members 21. This mirror surface 22 reflects light back towards the irregular surfaced diffuser panel 23. During daylight hours the presence of a light source, LED lights 21, are hidden from view by the diffuser panel 23 which diffuses ambient day time light from the reflective surface 22 out towards the viewer.

### LIST OF DRAWING REFERENCES

20. Light guide frame
21. Light emitting diode (LED)
22. Mirrored reflective surface
23. Prismatic crushed iced diffuser

I claim:

1. A mirrored reflective display and diffuser unit wherein a plurality of LED's are aligned along the rear surface of the unit evenly spaced about said unit along the mirror planar surface;
a second sheet above said mirror sheet acts as a diffuser;
and, the display and diffuser units are available in a plurality of uses and or applications, including but not limited to box signs, commercial signs, individual alpha numeric characters, symbols, logos and freeway signs;
a message board wherein a fixed controller system controls its displays; and
where the reflective display and diffuser system may or may not include LED's.

2. A mirrored reflective display and diffuser unit according to claim 1, wherein said diffuser sheet consists of a planar back surface and an irregular crushed ice front surface.

3. A mirrored reflective display and diffuser unit according to claim 2, wherein said diffuser sheet has a separation factor of zero, where the sheet rests atop LED's to one half an inch away from LED's mounted on the mirrored rear surface.

4. A mirrored reflective display and diffuser unit according to claim 2, wherein said diffuser sheet blocks a viewers sight of the LED's when illumination is turned off, allowing for only the distinct reflection of ambient light without glare, off its surface.

5. A mirrored reflective display and diffuser unit according to claim 1, wherein said mirrored reflective display sheet houses a plurality of flathead LED lights and are wired in series or parallel along the back of said mirrored sheet.

6. A mirrored reflective display and diffuser unit according to claim 1, wherein said display and diffuser unit is incorporated into a illuminated box sign.

7. A mirrored reflective display and diffuser unit according to claim 6, wherein said illuminated signs diffuser panel causes an enlarging bulb effect on the illuminated LED members greatly enhancing the signs readability thereof.

8. A mirrored reflective display and diffuser unit according to claim 7, wherein said illuminated LED members' globe like effect is further enlarged by a greater separation of the diffuser sheet from the mirrored LED display panel.

9. A mirrored reflective display and diffuser unit according to claim 6, wherein said illuminated sign possesses a border of crushed ice diffusing sheeting immediately surrounding the characters of the face panel with a visible reflective sparkling effect in light or darkness independent of said signs illumination members.

10. A mirrored reflective display and diffuser unit according to claim 1, wherein said display and diffuser unit is incorporated into a commercial sign.

11. A mirrored reflective display and diffuser unit according to claim 10, wherein said commercial sign is composed of individual characters.

12. A mirrored reflective display and diffuser unit according to claim 11, wherein individual characters are three dimensional and come in a plurality of shapes and sizes.

13. A mirrored reflective display and diffuser unit according to claim 12, wherein said individual characters consists of a character shaped frame of plastic or metal whereby the mirrored display layer and the diffuser sheeting are enclosed.

14. A mirrored reflective display and diffuser unit according to claim 1, wherein said display and diffuser unit is incorporated into a message symbol.

15. A mirrored reflective display and diffuser unit according to claim 1, wherein said display and diffuser unit is incorporated into a logo.

16. A mirrored reflective display and diffuser unit according to claim 1, wherein said display and diffuser unit is incorporated into freeway signs by means of retrofitting existing signs.

17. A mirrored reflective display and diffuser unit according to claim 16, wherein said freeway signs are retrofitted by three dimensional single character letters, numbers or symbols.

18. A mirrored reflective display and diffuser unit according to claim 16, wherein said freeway signs incorporate a plurality of LED illumination units per character thereby drastically reducing the use of electricity needed to illuminate said sign.

19. A mirrored reflective display and diffuser unit according to claim 1, wherein said message board functions are governed by a fixed controller unit.

20. A mirrored reflective display and diffuser unit according to claim 19, wherein said message board consists of fixed characters comprising a message and display.
